(19) United States
(12) Patent Application Publication
(10) Pub. No.: US 2015/0250148 A1
(43) Pub. Date: Sep. 10, 2015

(54) Squirrel Deterrent Support for Bird Feeder

(71) Applicant: Bruce Rubin, VOORHEES, NJ (US)

(72) Inventor: Bruce Rubin, VOORHEES, NJ (US)

(21) Appl. No.: 14/620,290

(22) Filed: Feb. 12, 2015

Related U.S. Application Data
(60) Provisional application No. 61/947,770, filed on Mar. 4, 2014.

(51) Int. Cl. A01K 39/01; A01K 29/00

(52) U.S. Cl. CPC A01K 39/0113; A01K 29/00

(57) ABSTRACT

A squirrel deterrent support for a bird feeder includes an elongated rigid substantially straight pole of at least five feet in length. A hook at the upper end supports a bird feeder and a bracket at the lower end supports the pole on a fixed surface so that it extends upwardly and outwardly at an angle of about 60°. A plurality of elongated tubes surround the pole and include bearings at each end so as to rotate around the pole. Each tube carries a barrier in the form of fan blades that extend radially outwardly and rotate with the tube. A circular baffle in the form of an inverted bowl is carried by the pole above the barriers.

### CROSS REFERENCE TO RELATED APPLICATION

This application claims the benefit of Provisional Patent Application No. 61/947,770, filed Mar. 4, 2014.

### FIELD OF THE INVENTION

The present invention relates generally to a bird feeder apparatus. More specifically, the present invention relates to a pole for suspending or holding a bird feeder, where the pole incorporates a series of devices for the purpose of inhibiting squirrels (or other animals) from climbing the pole or otherwise gaining access to the bird feeder.

### BACKGROUND OF THE INVENTION

Millions of people around the world enjoy feeding and watching birds. Frequently, this is done using bird feeders suspended from or mounted on posts or poles in their yards or extending from a porch rail or the like. This enjoyment is frequently interrupted by the sight of a squirrel climbing up the post and stealing the birdseed from the feeder. A single squirrel can eat more food than even a number of birds, which means the feeder quickly becomes empty. The owner must frequently refill the feeder with bird food in order to again attract the birds and ensure that the birds have a sufficient food. This frequent replacement of food can become costly and inconvenient. Furthermore, a squirrel eating from a bird feeder scares off the birds, defeating the owner's purpose of having the feeder. Even further, many bird feeders and poles may not be designed to withstand the extra weight of a squirrel or two and may become damaged from the additional weight.

Many arrangements have been proposed over the years to deter squirrels (and other such pests) from reaching bird feeders. These prior art attempts, however, have commonly failed since squirrels are by nature extremely agile and cunning animals. Strategies at keeping animals away from feeders include altering the post the bird feeder sits atop making it slippery and thereby more difficult for squirrels to climb. Yet, the squirrels often still are able to overcome this obstacle, and reach the bird feeder.

Other proposed attempts to prevent squirrels from climbing completely to the top of the pole and bird feeder include, for example, U.S. Pat. No. 2,891,508 to Bower which discloses a squirrel guard comprising an annular plate having a center hole. The guard is slipped under the pole holding the bird feeder with the pole extending through the hole. The guard is then supported on the pole below the bird feeder by a spring. The device is capable of inclined movement upon animal contact, returning to a nearly perpendicular plane to the pole upon animal release.

U.S. Design Pat. No. D174,139 to Sadler discloses an ornamental design for a bird feeding station incorporating a barrier located beneath the bird feeder. The barrier appears to slope downward from the pole of the bird feeding station.

Various other barriers have been proposed to prevent a squirrel from reaching the feeder. These include cylindrical shaped barriers such as disclosed in U.S. Design Pat. No. D449,719 to Nylen, or flat disc-shaped devices such as shown in U.S. Pat. No. 4,523,546 to Latham, or inverted disc-shaped devices such as taught in U.S. Pat. No. 6,098,348 to Weaver, or dome-shaped devices like the version shown in U.S. Pat. No. 4,031,856 to Chester.

Wittman, U.S. Pat. No. 5,313,910, suggests the combination of disc shaped washers and tubes mounted on the pole adjacent the bottom thereof. Other approaches include the use of devices that dynamically interrupt the access by a squirrel through the use of motion, such as shown in U.S. Pat. No. 6,532,894 to Johnson where the up-and-down motion of that device discourages the squirrel from climbing the post.

Unfortunately, the prior art devices known to Applicant do not reach the satisfaction level of the user insofar as preventing squirrels from reaching the bird feeders. Sometimes this arises from the squirrel's uncanny ability to “learn” the approach for deterrence and to seek ways to evade the device. This is true because the known prior art devices tend to rely upon a single effect to bar the squirrels from climbing, when the use of multiple effects create a much greater degree of difficulty for the animal. In addition, many of the prior art devices may work initially but fail to work after being exposed to the elements which prevents parts from moving as they were designed to do.

While the prior art devices may have some usefulness, they are clearly not satisfactory. There is, therefore, a need for a squirrel deterrent that will effectively prevent squirrels and other animals from climbing a pole to reach a bird feeder suspended from or attached to the top thereof.

### SUMMARY OF THE INVENTION

The present invention is designed to overcome the deficiencies of the prior art discussed above. Accordingly, it is an object of the present invention to provide a squirrel deterrent support for a bird feeder that is effective in preventing squirrels and other animals from reaching the bird feeder.

It is a further object of the present invention to provide a squirrel deterrent support for a bird feeder that is easy to install and maintain.

It is a still further object of the invention to provide a squirrel deterrent support for a bird feeder that will continue to function properly even after many years of being exposed to the elements.

In accordance with the illustrative embodiments demonstrating features and advantages of the present invention, there is provided a squirrel deterrent support for a bird feeder that includes an elongated rigid substantially straight pole of at least five feet in length. A hook at the upper end of the pole supports a bird feeder thereon and a bracket at the lower end supports the pole on a fixed surface so that the pole extends upwardly and outwardly at an angle of about 60°. A plurality of elongated tubes surround the pole and include bearings at each end so as to rotate around the pole. Each tube carries a barrier in the form of fan blades that extend radially outwardly and rotate with the tube. A circular baffle in the form of an inverted bowl is carried by the pole above the barriers.

Other objects, features, and advantages of the invention will be readily apparent from the following detailed description of a preferred embodiment thereof taken in conjunction with the drawings.

### BRIEF DESCRIPTION OF THE DRAWINGS

For the purpose of illustrating the invention, there is shown in the accompanying drawings one form which is presently preferred; it being understood that the invention is not intended to be limited to the precise arrangements and instrumentalities shown.

FIG. 1 is a side elevational view of a squirrel deterrent support for a bird feeder according to the preferred embodiment of the invention;

FIG. 2 is a front elevational view thereof, and

FIG. 3 is an enlarged view of a portion thereof, and with portions broken away, showing the bearings mounting the tube to the pole.

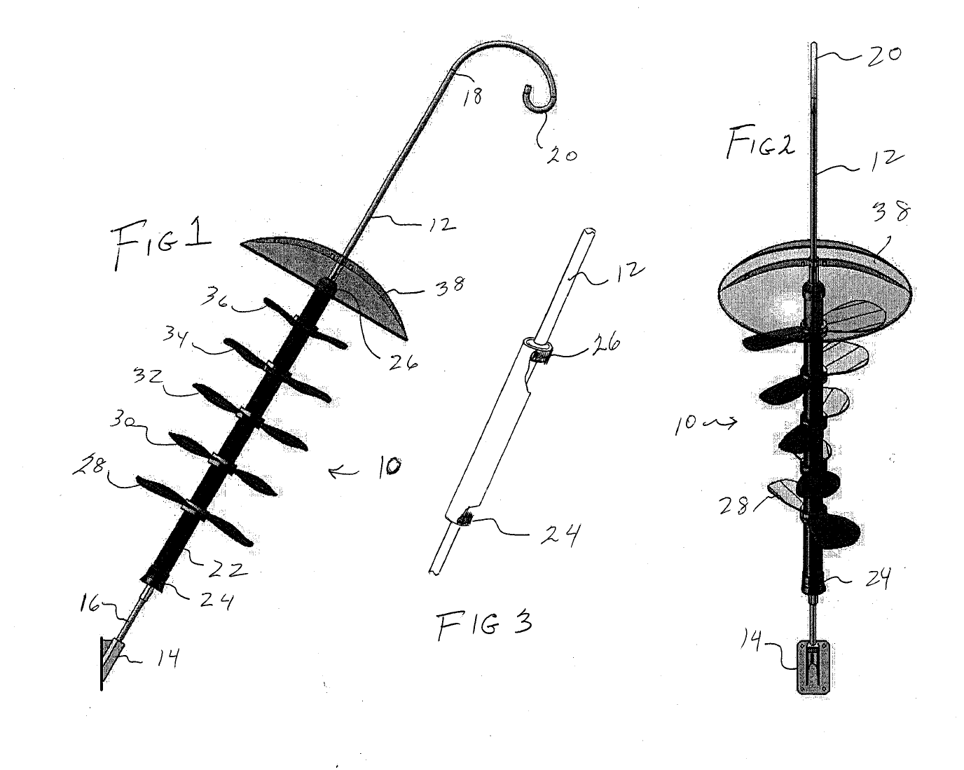

### DETAILED DESCRIPTION OF THE PREFERRED EMBODIMENT

Referring now to the drawings in detail wherein like reference numerals have been used throughout the various figures to designate like elements, there is shown in each of the figures a squirrel deterrent for a pole mounted bird feeder constructed in accordance with the principals of the present invention and designated generally as 10. The device 10 includes an elongated rigid substantially straight pole 12. The pole 12 is preferably made of a tubular metal which is capable of withstanding the elements such as rain and the like. It is preferably between 0.5 to 1 inch outer diameter so that it will be rigid enough to maintain its shape.

A mounting bracket 14 located at the lower end 16 of the pole 12 is adapted to be attached to a horizontal surface such as the wall of a building or the like so as to support the pole 12 in a position wherein it is between about 45° and about 75° from the horizontal. Preferably the pole 12 should extend at an angle of approximately 60° from the horizontal.

The bracket 14 is, of course, by way of example only. Other types of brackets or supports could be utilized. This would necessarily depend on the structure to which the device 10 is to be attached. Furthermore, It is not beyond the scope of the present invention to provide a tripod or the like to support the lower end 16 of the pole 12 directly on the ground.

Secured to the upper end 18 of the pole 12 is a hook 20 or the like which is adapted to allow a bird feeder to be suspended therefrom. The hook 20 is also by way of example only since it is also possible to mount a bird feeder at the upper end 18 of the pole 12 from the underside of the bird feeder rather than suspending the bird feeder from the hook 20.

A tube 22 having a length of between approximately 2 feet and 3 feet is mounted on the pole 12. The diameter of the tube 22 is preferably 1.5 inches to 3 inches so as to loosely fit around the pole 12. A bearing 24 between the bottom of the tubular member 22 and the pole 12 and a bearing 26 between the upper end of the tube member 22 and the pole 12 allow the tube 22 to rotate freely about the pole 12. By providing bearings only at the bottom and top of the tube 22, the tube will rotate freely even if the pole 12 bends slightly.

Although a single tube 22 is being described, this is also by way of example. It is possible to employ a plurality of tubes end to end. If that were done, each tube would be mounted on bearings at the top and bottom thereof and all would freely rotate about the pole 12.

A number of barriers in the form of fan blades such as shown, for example, at 28, 30, 32, 34 and 36 are carried by the tube 22 so as to rotate about the pole 12. While five such pairs of fan blades are shown, it should be readily apparent to those skilled in the art that fewer or more pairs of blades may be used. It has been found, however, that at least one pair of fan blades (or similar barrier) is necessary for the proper operation of the invention.

The barrier members or fan blades 28-36 can either be fixed to the tube 22 so as to rotate therewith and/or may also be mounted thereon so as to be rotatable relative to the tube 22. Furthermore, while the barrier members are shown as fan blades, they could take other shapes such as round poles or the like extending outwardly from the tube 22.

A circular baffle 38 in the form of an inverted bowl is mounted on the pole 12 above the fan blade barriers. The baffle 38 is preferably mounted on the pole 12 so as to rotate therewith. To accomplish this, there may be an additional bearing between the center of the baffle 38 and the pole 12 or the baffle 38 could be secured to the upper end of the tube 22. In any event, the diameter of the baffle 38 is greater than the width of the barriers or blades 28-36. That is, the baffle 38 extends radially outwardly beyond the barriers.

The present invention may be embodied in other specific forms without departing from the spirit or essential attributes thereof and accordingly, reference should be made to the appended claims rather than to the foregoing specification as indicating the scope of the invention.

I claim:

1. A squirrel deterrent support for a bird feeder comprising:
an elongated rigid substantially straight pole having a length of at least five feet and having an upper end and a lower end;
means adjacent said upper end for supporting a bird feeder thereon;
means adjacent said lower end for supporting said pole on a fixed support surface such that said pole extends upwardly and outwardly at an angle of between about 45° and about 75° from the horizontal;
at least one elongated tubular member surrounding a portion of said pole, said tubular member having a first end and a second end, rotary bearings at said first end and at said second end of said tubular member cooperating with said pole such that said tubular member rotates about said pole by way of said bearings, and
a barrier carried by said at least one tubular member and mounted for rotation therewith about said pole, said barrier extending radially from said pole and having a diameter of between about 12 inches to about 18 inches.

2. The squirrel deterrent support as claimed in claim 1 further including a circular baffle carried by said pole above said barrier and extending radially outwardly beyond said barrier.

3. The squirrel deterrent support as claimed in claim 2 wherein said baffle is in the shape of an inverted bowl.

4. The squirrel deterrent support as claimed in claim 1 wherein said barrier is in the form of a plurality of fan blades.

5. The squirrel deterrent support as claimed in claim 1 including a hook adjacent said upper end of said pole for supporting a bird feeder.

6. The squirrel deterrent support as claimed in claim 1 including a plurality of said elongated tubular members surrounding a portion of said pole, each of said tubular members having a first end and a second end and each of said tubular members including rotary bearings at said first end and at said second end of each of said tubular members cooperating with said pole such that all of said tubular members rotate about said pole by way of said bearings.

7. The squirrel deterrent support as claimed in claim 6 further including a plurality of barriers, each barrier being mounted on a different one of said tubular members for rotation therewith.

8. The squirrel deterrent support as claimed in claim 7 wherein each of said barriers is in the form of a plurality of fan blades.

9. The squirrel deterrent support as claimed in claim 1 wherein said pole extends upwardly and outwardly at an angle of about 60°.
